(19) United States
(12) Patent Application Publication
(10) Pub. No.: US 2005/0059299 A1
(43) Pub. Date: Mar. 17, 2005

(54) Memory card connector

(76) Inventors: ZiQiang Zhu, Kunsan (CN); Guohua Zhang, Kunsan (CN); Kechang Wei, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/940,348

(22) Filed: Sep. 13, 2004

(30) Foreign Application Priority Data
Sep. 12, 2003 (TW) 92216481

(51) Int. Cl. H01R 13/648

(52) U.S. Cl. 439/607

(57) ABSTRACT

A memory card connector (100) includes an insulative housing (1), a housing shield (2) enclosing the housing and a circuit module (3) with a plurality of conductive terminals. The insulative housing includes a generally U-shape body portion (10). The insulative housing has a first and second locking barbs (120, 122) in a side thereof. The housing shield is composed of an upper and a lower cover plates (20, 21). The lower cover plate forms an upwardly bent first latch portion (24) for engaging with the first locking barb of the housing. The upper cover plate forms a downwardly bent second latch portion (25) for latching the second locking barb of the housing, thereby securely holding the housing in the shield.

### BACKGROUND OF THE INVENTION

1. Field of the Invention

The present invention relates to an electrical connector and more particularly, to a memory card connector.

2. Description of the Prior Art

Electrical cards are widely used in electrical devices for storing information. Generally, card connectors are used for interconnecting the electrical cards with the electrical devices. A related conventional card connector is disclosed in U.S. Pat. No. 6,524,137 B1. The conventional card connector includes an insulative housing and a shield. The shield comprises upper and lower cover plates shielding the insulative housing. The cover plates each perpendicularly form a pair of locking tabs on two ends thereof. The housing defines a plurality of receiving slits for receiving the locking tabs, thereby retaining the cover plates thereon. However, due to the cover plates interlock with housing only through engagement of the locking barbs and the receiving slits, therefore, the cover plates may break away from the housing under extrusion. In addition, locking tabs are very tiny and are easily fractured during inserting into the slits, thereby decreasing locking function of the whole cover plates.

Hence, an improved electrical connector incorporating electrical connectors of different types and providing good signal transmitting quality is desired to overcome the foregoing shortcomings.

### BRIEF SUMMARY OF THE INVENTION

A main object of the present invention is to provide a memory card connector having a shield securely and conveniently holding the insulative housing therein.

To attain the above object, a memory card connector according to the present invention includes an insulative housing, a housing shield enclosing the housing and a circuit module with a plurality of conductive terminals. The insulative housing includes a generally U-shape body portion. The insulative housing has a first and second locking barbs in a side thereof. The housing shield is composed of an upper and a lower cover plates. The lower cover plate forms an upwardly bent first latch portion for engaging with the first locking barb of the housing. The upper cover plate forms a downwardly bent second latch portion for latching the second locking barb of the housing, thereby securely holding the housing in the shield.

Other objects, advantages and novel features of the invention will become more apparent from the following detailed description when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector according to the present invention;

FIG. 2 is another perspective view of FIG. 1;

FIG. 3 is an exploded view of FIG. 1;

FIG. 4 is partially exploded view of FIG. 1; and

FIG. 5 is another partially exploded view of FIG. 1.

### DETAILED DESCRIPTION OF THE INVENTION

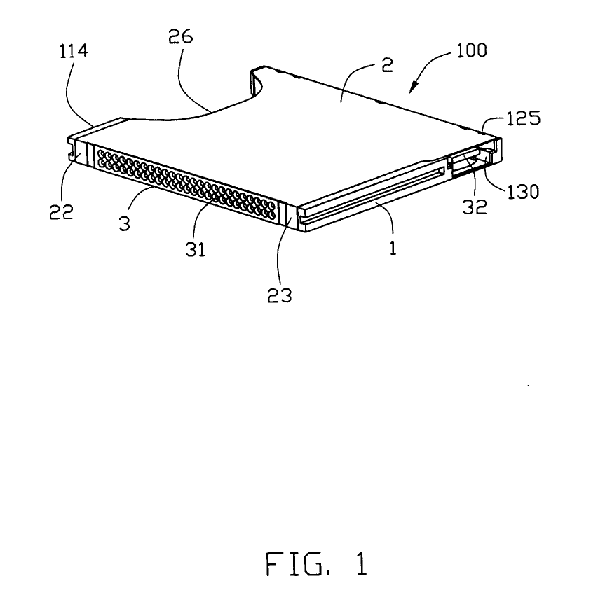

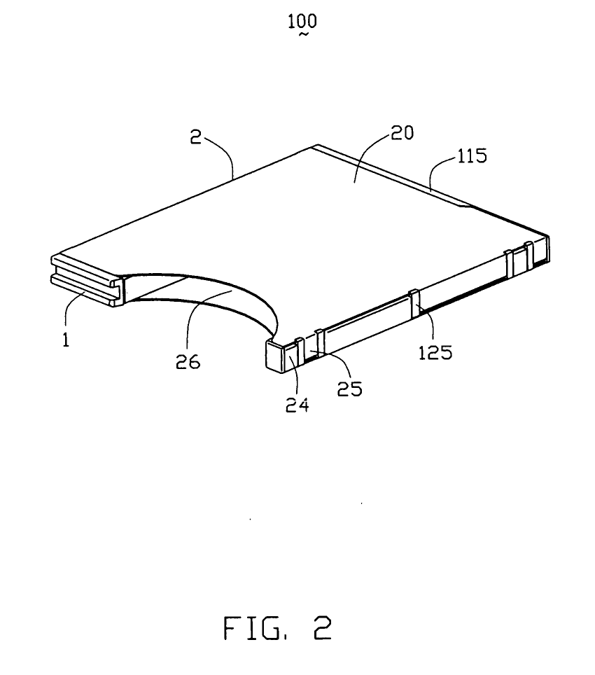

Referring to FIGS. 1-2, a memory card connector according to the present invention includes an insulative housing 1, a housing shield 2 and a circuit module 3 mounted on the housing 1.

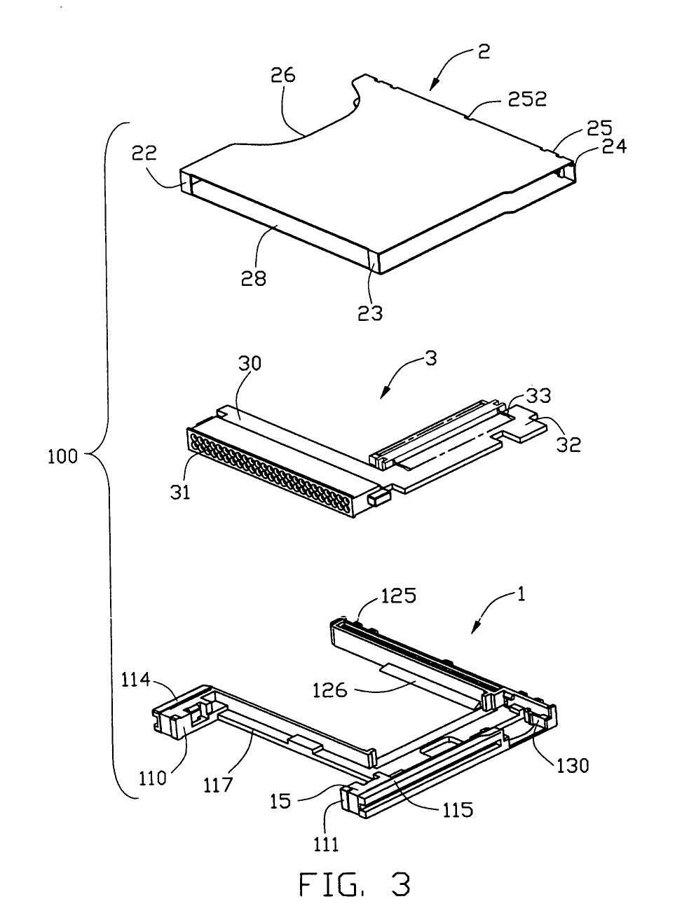

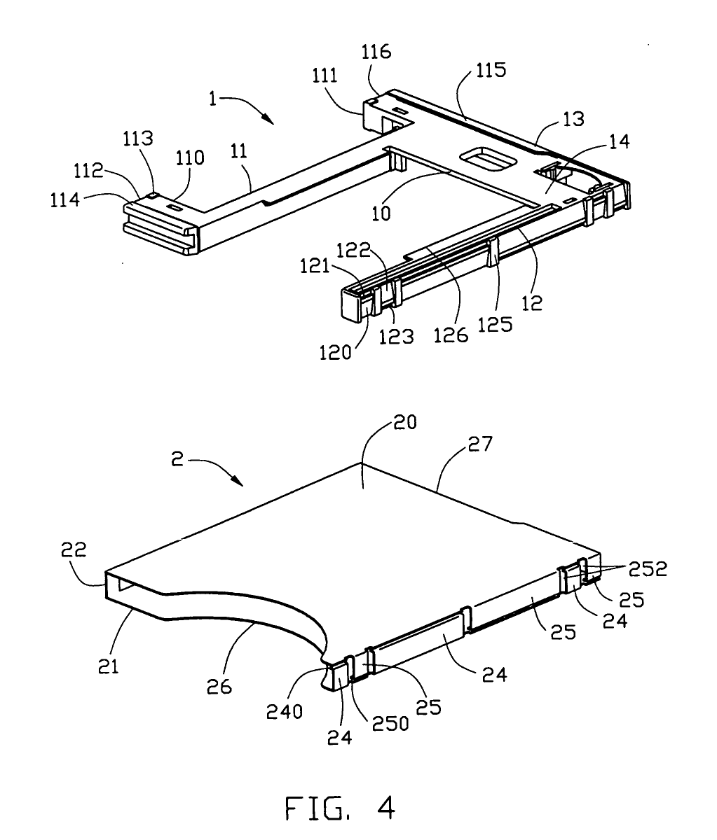

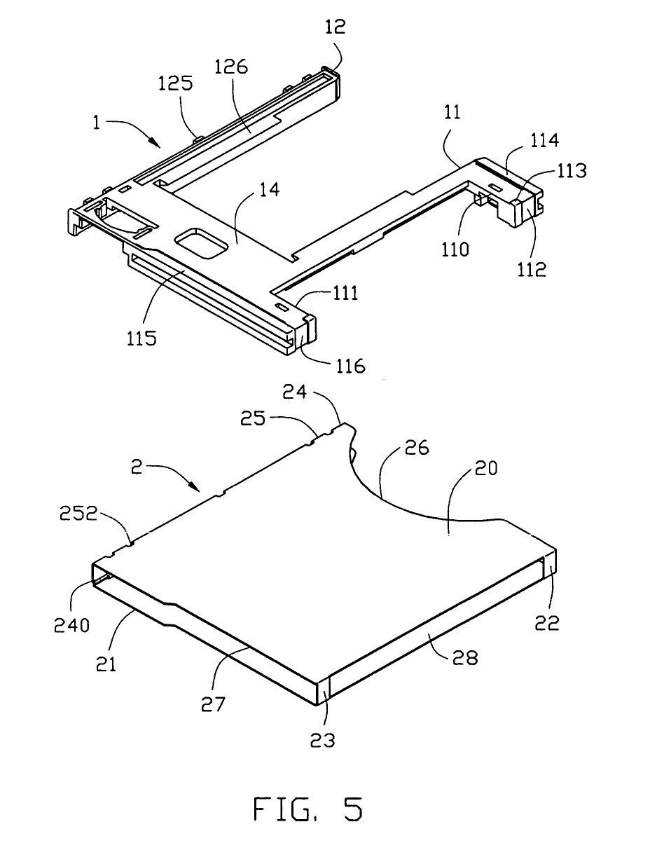

Referring to FIGS. 3-5, the housing 1 includes a generally U-shaped body portion 10, the body portion 10 comprises a top surface 14 and a bottom surface 15 and is composed of left and right side beams 11, 12 and a cross beam 13 extending between the side beams 11, 12 to link rear ends of left and right side beams 11, 12. The left side beam 11 comprises a pair of extending arms 110 and 111 leftward extending from front and rear ends thereof, respectively. The cross beam 13 defines a through recess 130 in the bottom surface 15 thereof. The side beams 11, 12 respectively have an engaging piece 126 inwardly projecting from a generally middle portion of a top surface thereof for restricting movements of an inserted card in top-and-bottom directions. The left side beam 11 longitudinally defines a cut-away step portion 117 through an outer side surface and a lower surface thereof. The right side beam 12 comprises a plurality of pairs of first and second wedge-shaped locking barbs 120, 122 alternately projecting from an outside thereof. The first locking barb 120 comprises an upper portion and a lower portion, the upper portion is wider than the lower portion, thereby forming an upper hook portion 121 toward the top surface of the right side beam 12. The second locking barb 122 comprises an upper portion and a lower portion, the upper portion is narrower than the lower portion, thereby forming a lower hook portion 123 toward a bottom surface of the right side beam 12. A generally rectangular locking block 125 positions between each pair of the first and second locking barbs 120, 122. The extending beams 110, 111 respectively define grooves 112, 116 in left ends thereof. A plurality of elongate retaining blocks 114, 115 project from the top and bottom surfaces 14 and 15 of the insulative housing 1, thereby forming a recessed engaging surface (not labeled) in the top and bottom surfaces 14 and 15 of the housing 1. The retaining blocks 114 project outwardly along front side of top and bottom surfaces of the extending arm 110. The retaining blocks 115 projects outwardly along rear sides of cross beam 13 and the extending arm 111.

The housing shield 2 is generally of flat square cassette and comprises an upper cover plate 20 and a lower cover plate 21 for receiving an insulative housing 1 therebetween. A recessed arciform cut-out 26 is defined in a front edge of each cover plate 20, 21 for facilitating inserting or extracting a card. The shield 2 further includes a rear edge 27 thereof for engaging with the retaining block 115 of the housing 1. A pair of connecting tabs 22, 23 integrally connect left sides of the cover plates 20, 21. An opening 28 is defined by the connecting tabs 22, 23 and left sides of the cover plates 20, 21. The lower cover plate 21 comprises a plurality of intermittent first latch portions 24. Each first latch portion 24 is upwardly bent from the lower cover plate 21 for engaging the locking barb 120 of the right beam 12 of the housing 1. A first hold portion 240 is inwardly bent from each first latch portion 24 for locking a corresponding upper hook portion 121 of the first locking barb 120.The upper cover plate 20 comprises a plurality of intermittent second latch portions 25. Each second latch portion 25 is downwardly bent from the upper cover plate 20 for engaging the locking barb 122 of the right beam 12 of the housing 1. A second hold portion 250 is inwardly bent from each second latch portion 25 for locking a corresponding lower hook portion 123 of the second locking barb 122. The housing shield defines a plurality of receiving recesses 252 between adjacent latch portions 24, 25 for engaging with corresponding locking blocks 125 of the housing 1.

Referring to FIG. 3, the circuit module 3 comprises a generally L-shaped circuit board 30 and a first mating portion 31 positioned on a left side of the circuit board 30. The circuit board comprises a plurality of conductive terminals 33 received therein for electrically connecting with the memory card. In addition, the circuit module 3 defines a second mating portion 32 positioned in a rear end of the circuit board 30 received in the through recess 130 of the cross beam 13 of the housing 1. The mating portions 31, 32 respectively connect with external circuits (not shown).

Referring to FIGS. 1-5, in assembly, the circuit module 3 is mounted on the bottom surface 15 of the insulative housing 1, with the first mating portion 31 of the circuit module 3 mounted between the extending arms 110, 111 in the cut-away step portion 117 of the housing 1, and with the second mating portion 32 received in the through recess 130 of the cross beam 13 of the housing 1. The housing shield 2 encloses the housing 1, front and rear edges of the shield 2 engage with the retaining blocks 114, 115 of the housing 1 so that the shield 2 securely closes the housing 1. The cut-out 26 of the shield 2 engages with the U-shaped body portion 10 of the housing 1. The engaging pieces 126 of the left and right side beams 11, 12 securely closes with an inter surface of the shield 2 so that forms a receiving room (not labeled) for receiving a memory card. The connecting tabs 22, 23 positioned on one side of the housing shield 2 respectively hook the grooves 112, 116 of the front and rear extending arms 110, 111 of the left side beam 11 of the housing 1. The rear edge 27 of the shield 2 engages with the first mating portion 3 of the circuit board 3. The first and second latch portions 24, 25 of shield 2 respectively locking with the corresponding locking barbs 120, 122 of the right beam 12 of the housing 1. The first and second hold portions 240, 250 respectively hold corresponding hook portions 121, 123 of the right side beam 12 of the housing 1. The locking blocks 125 secure with corresponding receiving recesses 252 of the shield 2, therefore, the housing 1 securely holds the shield 2.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. A memory card connector, comprising:
an insulative housing including a body portion, said housing having a first and second locking barbs on a side thereof, said first locking barb defining a first hook portion adjacent to a top surface of the housing, second locking barb defining a second hook portion adjacent to a bottom surface of the housing;
a plurality of conductive terminals; and
a housing shield enclosing said housing and forming a first latch portion and a second latch portion, said first and second latch portions of the shield respectively forming a first and second hook-shaped hold portions for engaging with said first and second hook portions of the housing.

2. The memory card connector according to claim 1, wherein the housing shield comprises an upper cover plate and a lower cover plate, and wherein said cover plates comprise a tab, said upper and lower cover plates being unitarily connected by a tab.

3. The memory card connector according to claim 1, wherein the first locking barb comprises an upper portion and a lower portion, the upper portion is wider than the lower portion, and wherein the second locking barb comprises an upper portion and a lower portion, the upper portion is narrower than the lower portion.

4. The memory card connector according to claim 1, wherein said insulative housing comprises a locking block positioned between the locking barbs, and wherein said housing shield defines a receiving recess between the latch portions for engaging with said locking block of the housing.

5. The memory card connector according to claim 1, wherein said housing forms front and rear retaining blocks projecting from the top surface thereof for respectively engaging with front and rear edges of said shield.

6. The memory card connector according to claim 1, wherein said body portion comprises a pair of side beams and a cross beam extending between the side beams, said locking barbs being formed on at least on of the side beams.

7. The memory card connector according to claim 1, wherein said memory card connector further includes a circuit module mounted on said insulative housing, and wherein said conductive terminals are received in the circuit module.

8. The memory card connector according to claim 7, wherein said circuit module defines first and second mating portions for mating external circuits.

9. An electrical card connector assembly comprising:
a housing assembly defining a receiving space for receiving an electronic card along a first direction;
a first connection port disposed in the housing assembly for mechanically and electrically connected to said electronic card; and
a second connection port disposed in the housing assembly and electrically connected to the first connection port; wherein
said second connection port is exposed to an exterior, for connecting to a complementary electronic part, in a second direction being in a non-parallel relation with regard to the first direction.

10. The electrical card connector assembly as claimed in claim 9, wherein said second direction is perpendicular to said first direction.

11. The electrical card connector assembly as claimed in claim 9, wherein said housing assembly defines guiding rails along said second direction for insertion of the whole electrical card connector assembly into said complementary electronic part.

12. The electrical card connector assembly as claimed in claim 9, wherein said housing assembly includes at least one insulative housing.

13. The electrical card connector assembly as claimed in claim 9, wherein said housing assembly includes at least one metallic housing shield.

14. The electrical card connector assembly as claimed in claim 9, wherein said housing assembly includes an insulative housing enclosed in a metallic housing shield.

15. The electrical card connector assembly as claimed in claim 9, wherein said first connection port and said second connection port are electrically connected by a printed circuit board.

16. The electrical card connector assembly as claimed in claim 9, wherein said housing assembly defines a cutout for facilitating insertion or extraction of said electronic card.

17. A method of electrically connecting a small sized electronic card into a large sized receiving space, comprising:
providing an adaptor device with a small sized receiving space in a first direction, with a first connection port exposed to said small sized receiving space, and with a second connection port exposed to an exterior in a second direction being in a non-parallel relation with regard to the first direction, wherein said first connection port is electrically connected to the second connection port;
inserting the small sized electronic card into the small sized receiving space in said first direction and electrically connected to the first connection port; and
inserting the adaptor with the associated small sized electronic card into the large sized receiving space in said second direction for having the second connection port electrically connected to a complementary electronic part which defines said large sized receiving space.

18. The method as claimed in claim 17, wherein said first direction is perpendicular to said second direction.
